(19) United States
(12) Patent Application Publication
(10) Pub. No.: US 2002/0113759 A1
(43) Pub. Date: Aug. 22, 2002

(54) Telecommunications switching array using optoelectronic display addressing

(76) Inventors: Jules D. Levine, Santa Clara, CA (US); Ross LaRue, Milpitas, CA (US); Stepan Essaian, San Jose, CA (US)

Correspondence Address: PILLSBURY WINTHROP LLP, East Tower, Ninth Floor, 1100 New York Avenue, N.W., Washington, DC, 20005-3918, US

(21) Appl. No.: 09/788,332

(22) Filed: Feb. 16, 2001

(51) Int. Cl. G09G 3/20

(52) U.S. Cl. 345/55

(57) ABSTRACT

A telecommunication switching array uses optical-electrical display addressing to eliminate the need for control lines by using only external controls to indicate the active nodes of the array. The external controls are integrated in a flat panel display, and the easily addressed display is coupled optically to the switching array through integrated photodconductors located adjacent to the switches. There is one photoconductor for each switch. This results in a separation of control functions and switching functions which is embodied in a separate control plate and a separate switching plate. A third intermediate plate may be included for optical isolation and optional optical magnification. The array may be scaled for high-dimensional systems (e.g., an N×N array where N is 1,000 or more).

### BACKGROUND OF THE INVENTION

1. Field of Invention

The present invention relates to an analog switching array and more particularly to an analog switching array with switch elements that include photoconductors that are controlled by optical signals.

2. Description of Related Art

FIG. 11 illustrates a permutation switching element for use in the telecommunications industry. At each node there is the possibility of a connection between the input rows and the ouput columns. For example, Input r2 is connected to output s3 as shown in the diagram There are N! different configurations possible in a permutation switch of dimension N (e.g., N=6 in FIG. 1). The important case where there are N inputs and N outputs is called an N×N switch or more generally an N×N array, where an array may be made from a combination of switching elements.

In the case of an analog N×N switching array for microwave signals, such as those used in telecommunications, there are typically N inputs, N outputs, N² switches, and at least N² control lines that connect the switches to external voltage sources. For a large array with 1,000 switches, there are at least 1,000,000 control lines to be connected from the interior of the switch array to the exterior of the switch array, thereby adding substantial complexity to both the design and operation of the array.

### SUMMARY OF THE INVENTION

Accordingly, it is an object of this invention to provide an analog switching array with switches that are controlled by optical signals.

It is a further object to provide a switching array that is easily controlled without control lines at switches.

It is a further object to provide a switching array that desirably scales to high-dimensional systems.

The above and related objects of the present invention are realized by a switching array where input lines are connected to output lines by photconductors that act as optoeloctronic switches so that the photoconductors can be switched by light emitted by a corresponding projection system.

A preferred embodiment of a system for switching microwave signals according to the present invention includes an array plate, a frame, and a display projector. The array plate includes an array of analog switches having a plurality of input lines and a plurality of output lines, where the input lines are connected to the output lines by a by a plurality of photoconductors. The array plate includes a DC bias source for creating a voltage differential across the photoconductors, where the photoconductors are sufficiently doped so that exposure to light substantially affects the conductivity of the photoconductors; The display projector, which is connected to the array plate by the frame, includes a display surface and a light source, where the display surface faces the array plate and separates the display surface from the light source. The display surface includes at least one display aperture for transmitting light. Light emitted from the light source passes through a first display aperture and strikes a first photoconductor so that a circuit from a first input line to a first output line is completed.

The present invention enables the building of large-order switching arrays without the correspondingly large number of control lines typically required by conventional digital designs, which are further limited by available bit rates and array sizes. Switching can be accomplished by optical signals controlled by a projection display system, thereby avoiding the complexities associated with the wire-based control systems.

### BRIEF DESCRIPTION OF THE DRAWINGS

These and other objects and advantages of the invention will become more apparent and more readily appreciated from the following detailed description of the presently preferred exemplary embodiments of the invention taken in conjunction with the accompanying drawings, where:

FIG. 1 is a diagram of a preferred embodiment of an array plate according to the present invention;

FIG. 2 is a diagram of a preferred embodiment of a system for switching microwave signals according to the present invention;

FIG. 3 is a diagram illustrating the use of a preferred embodiment of a display surface according to the present invention;

FIG. 4 is a diagram of a preferred embodiment of a system including an intermediate plate for switching microwave signals according to the present invention;

FIG. 5 is a diagram of a specifically preferred embodiment of an array plate according to the present invention;

FIG. 6 is a diagram illustrating placement of Si (silicon) tiles on a quartz substrate according to the present invention;

FIG. 7 is a diagram of a preferred embodiment of a photoconductor with parallel geometry according to the present invention;

FIG. 8 is a diagram of a preferred embodiment of a photoconductor with right-angle geometry according to the present invention;

FIG. 9 is a diagram of a preferred embodiment of a photoconductor with parallel geometry including fingers according to the present invention;

FIG. 10 is a diagram illustrating the use of intermediate layer contacts and diffuse metallic contacts in a preferred embodiment of the present invention; and

FIG. 11 is a diagram illustrating a generic version of a switching array.

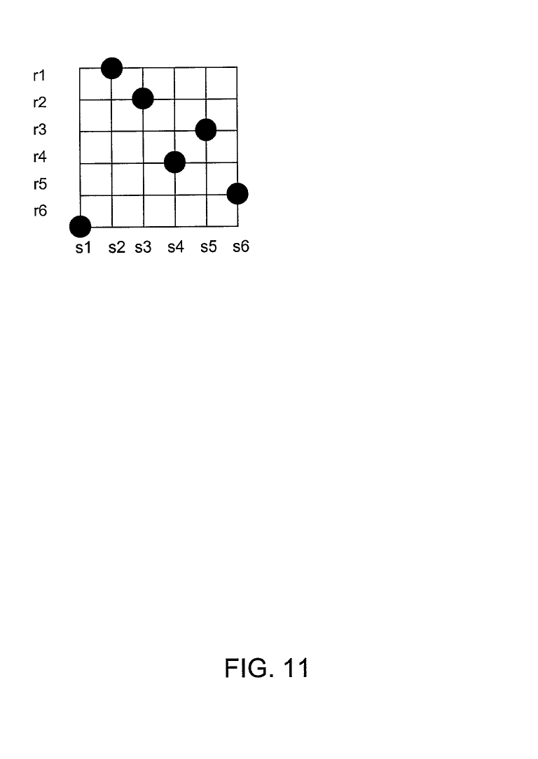

### DETAILED DESCRIPTION OF THE PRESENTLY PREFERRED EXEMPLARY EMBODIMENTS

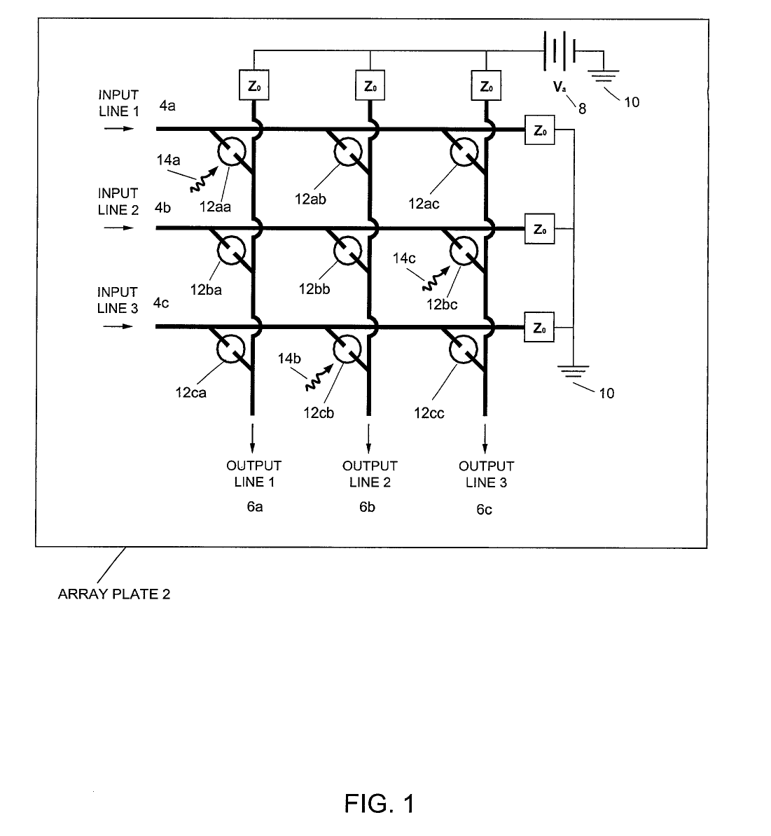

A preferred embodiment of the present invention is shown in FIG. 1. An array plate 2 includes multiple input lines 4a-4c and multiple output lines 6a-6c, where each line has a nominal impedance of Z₀=50 ohms. A DC voltage source 8 operates to maintain an applied voltage Vₐ on the output lines 6a-6c so that a voltage differential exists between the input lines 4a-4c and the output lines 6a-6c with respect to a common ground 10. In FIG. 1, the input lines 4a-4c are depicted as horizontal lines with inputs on the left-hand side. Each input line 4a-4c is a transmission line that carries an input microwave signal from left to right. The output lines 6a-6c are depicted as vertical lines with outputs at the bottom of the figure. Each output line 6a-6c is a transmission line that carries an output microwave signal from top to bottom.

The arrangement of the array plate 2 functions as an analog crosspoint switch array for switching microwave signals. Only three input lines 4a-4c and three output lines 6a-6c are shown in the embodiment of FIG. 1. More generally, there will be N input lines and N output line with N² switch elements, where N can be very large, for example, of the order of 1000.

Connections between input lines 4a-4c and output lines 6a-6c are made by multiple photoconductors 12aa-12cc located at nodes joining the input lines 4a-4c and the output lines 6a-6c. The photoconductors 12aa-12cc are fabricated from a semiconductor material with nearly intrinsic doping, which makes it highly resistive and most sensitive to light. In FIG. 1, each photoconductor 12aa-12cc is schematically shown as a disc that connects the two ends of a split transmission line in a diagonal juncture between each input line 4a-4c and output line 6a-6c. Because of the voltage source 8, a DC bias Of Vₐ volts exists across each photoconductor 12aa-12cc. The purpose of this DC bias is to allow the photoconductors 12aa-12cc to conduct in the presence of illumination. Details related to the composition and sizing of system components related to the photoconductors 12aa-12cc are presented below.

When not illuminated by light, each of the photoconductors 12aa-12cc has a very high resistance and low series capacitance, causing the switch to be OFF, and the input signal essentially passes horizontally along the corresponding input line 4a-4c from one node to the next with low loss. When focussed light of appropriate intensity is incident on one of the photoconductors 12aa-12cc, that photoconductor 12aa-12cc is activated so that it switches from an insulating state to a conductive state (i.e., from an OFF state to an ON state). When a photoconductor 12aa-12cc is in a conductive state, that photoconductor 12aa-12cc has a low series resistance so that an input signal in the corresponding input line 4a-4c is transmitted to the corresponding output line 6a-6c, whereby the photoconductor 12aa-12cc acting as a switch is ON.

In FIG. 1 the light is ON 14a, 14b, 14c at three photoconductors 12aa, 12cb, 12bc corresonding respectively to nodes joining the first row 4a to the first column 6a, the second row 4b to the third column 6c, and the third row 4c to the second column 6b. Each row is connected to only one column and vice versa.

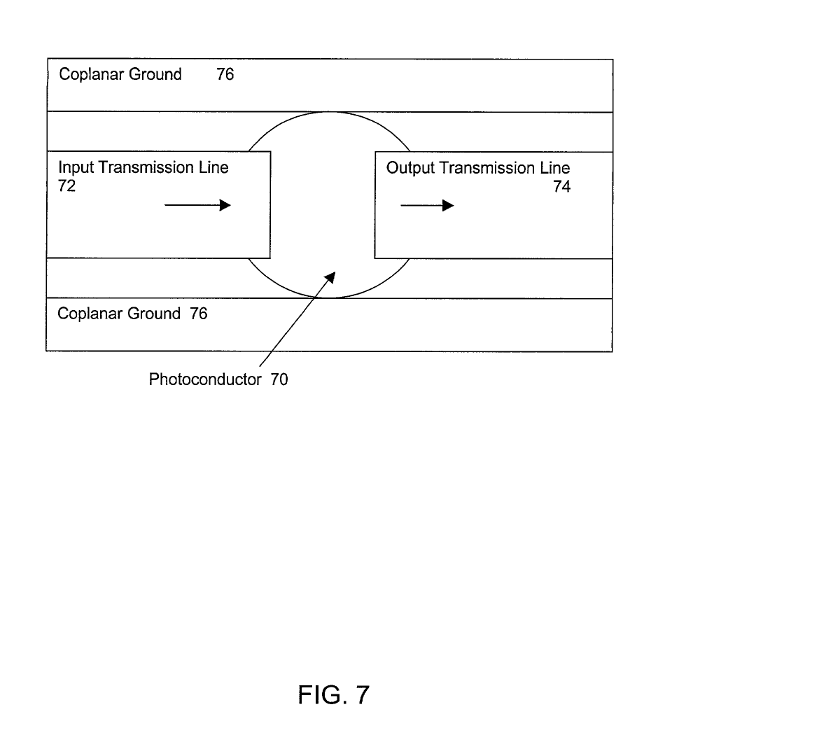

The photoconductor located at each node of the array plate 2 of FIG. 1 is part of a segmented parallel transmission line as shown in FIG. 7 in plan view. For the highest photoconductivity, it is desirable to focus light onto the circular region of the photoconductor 70 between the input 72 and output 74 transmission lines, all of which are insulated from a reference coplanar ground 76.

The system requirements depend on the resistance across the photoconductor 70 in the presence of emitted light. A suitable model has been developed under the conditions of ohmic contacts, unsaturated electron velocity, and no surface recombination. (“Concepts in Photoconductivity and Allied Problems”, Albert Rose, Interscience Publishers (1963), p. 6.) Under these conditions the resistance R (ohms) across the photoconductor 70 is given by:

R=(Eₚₕ*S)/(P*M*W*μ*τ) (1)

where Eₚₕ is the photon energy (volts), S is the spacing between the transmission lines (cm), P is the incident optical power (W/cm²) originating from the light source and incident on the photoconductor, M is the light multiplication factor, W is the width of the transmission line (cm), μ is the mobility (cm²/volt-sec), and τ is the electron lifetime (sec) in the conduction band of the highly pure semiconductor. The electron lifetime τ depends on the electron density induced by light. A preferred light source is a Nd/YAG laser with a wavelength of ˜532 nm. Under nominal conditions for embodiments utilizing conventional semiconductor materials, acceptable values for insertion loss and isolation are obtained.

For an embodiment involving GaAs (gallium arsenide), consider a 2 μm thick layer of intrinsic GaAs, with the following input parameters: S=0.0010 cm, W=0.0050 cm, P=2 W/cm², M=20, μ=8,500 cm²/volt-sec, and τ=10⁻⁷ sec. From Eq. 1, the resistance is R=14.7 ohms, which is a reasonable fraction of Z₀=50 ohms, a nominal value for the line resistance. When the switch is in the ON state, the insertion loss from the input row to the output column is given by

Insertion Loss=10*log[(¼)*(Z₀/(R+Z₀))²]˜−7.1 dB (2)

The capacitance for this configuration is C=10 fF. For f=40 GHz and y=2πf*C*Z₀˜0.126, the isolation is given by

Isolation=10*log[y²/(4*(1+y²))]˜−24.1 dB (3)

For an embodiment involving Si (silicon), consider a 10 μm thick layer of Si with the following input parameters: S=0.0010 cm, P=2.75 W/cm², M=20, μ=1,450 cm²/volt-sec, and τ=3.6*10⁻⁶ sec. From Eq. 1, the resistance is R=1.7 ohms. Then, the resulting insertion loss from Eq. 2 and isolation from Eq. 3 are comparable to the values obtained for the GaAs case.

Microwave signal transmission is not sensitive to a DC bias (e.g., from voltage source 8), except for the DC portion of the microwave signal, which is distorted by the DC bias. However, the detector circuit 70, 72, 74 used in this optical switching application is capacitively coupled. This means that the detector circuit does not measure the DC component of the microwave signal. Therefore, DC component of the microwave signal can be negated for this application.

In most applications, it is important that the photoconductor respond to high frequency light pulses (e.g., 1 MHz or greater). But in the application treated by the present invention, it is not important that the photoconductor have high responsivity to voltage changes at high frequencies. In this telecommunications switching array application the response time for voltage changes can be as long as one millisecond (i.e., a 1 KHz response) and still meet the system switching requirements. Therefore traditional indices of photoconductors regarding responsivity are substantially irrelevant for the context of the present application.

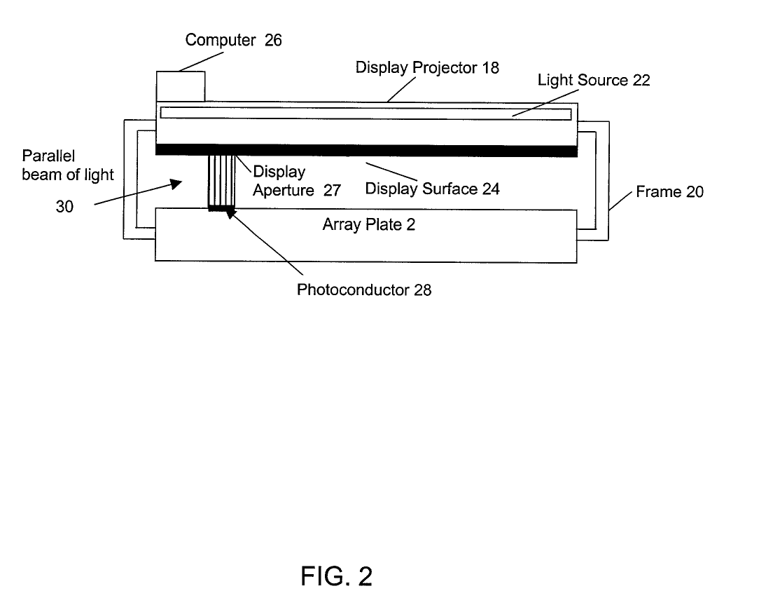

The array plate 2 of FIG. 1 may be used as a component of a system that includes a light source for activating the photoconductors 12aa-12cc. A preferred embodiment for a system 16 for switching microwave signals is illustrated in FIG. 2. The array plate 2 is connected to a display projector 18 by a frame 20 that is sufficiently rigid so as to maintain the relative orientation between the plate 2 and the projector 18. The display projector 18 includes a light source 22, a display surface 24 and a computer 26. The light source 22 generates nearly parallel light beams common in displays and can be obtained conventionally by means of a point light source and lens. The display surface 24 is responsive to program commands executing on the computer 26 for determining a display surface 24 that is substantially opaque except for apertures for transmitting light from the light source 22 to the array plate 2. FIG. 2 shows a single display aperture 27 that is positioned above a photoconductor 28 on the array plate 2 where a parallel beam 30 of light emitted from the light source 22 passes through the aperture 27 and strikes the photoconductor 28. The parallel beam 30 may include one or more pixels so that the photoconductor 28 is switched ON as discussed above.

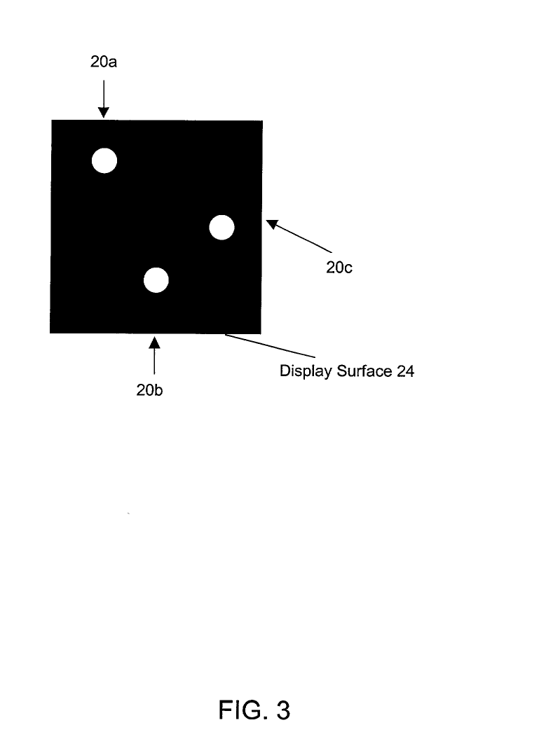

More generally, FIG. 3 shows a plan view of the display surface 24, where the surface is substantially opaque except for three apertures 20a-20c that correspond to the three incident beams 14a-14c of FIG. 1. The addressing and control of the two-dimensional positions of the apertures 20a-20c may be carried out by a conventional program such as PowerPoint™, and the display surface 24 may be chosen from conventional output devices for such programs where the pixel intensities on a two-dimensional surface may be programmed. For example, a PowerPoint™ program can be used to generate an array of illuminated dots consisting of a multiplicity of pixels in a circular pattern on a dark background.

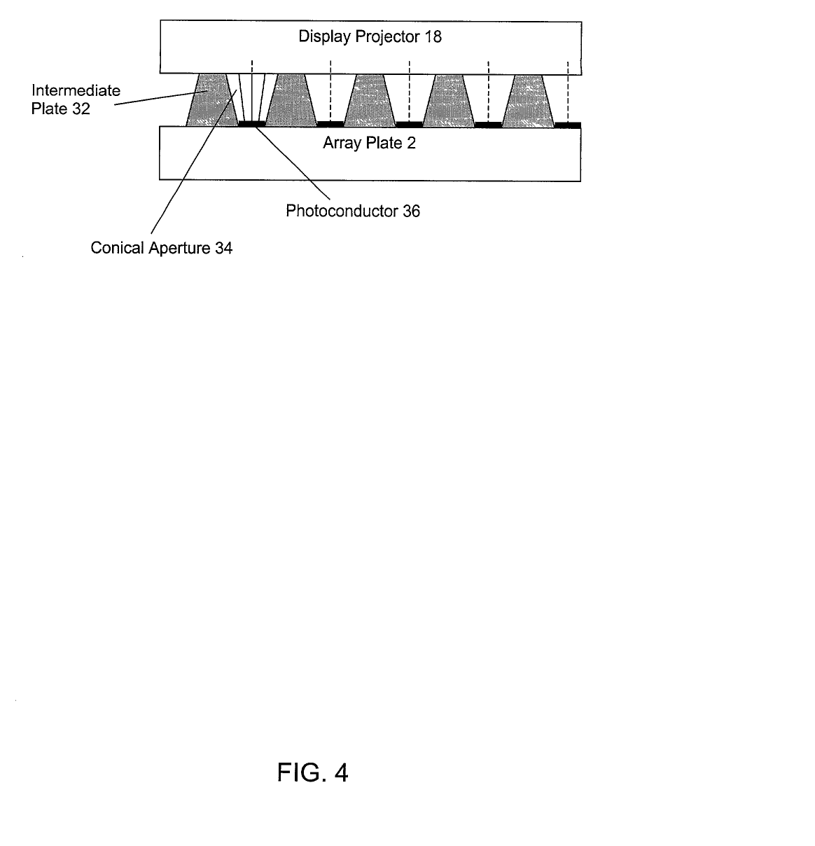

In addition to the array plate 2 and the display projector 18, additional components may be added for enhancing pixel isolation and focussing light. Isolation of one pixel from another may be accomplished by including a black matrix that prevents light leakage sideways from one pixel to another. Focussing of the light may be accomplished by including a lens that effectively multiplies the intensity of the light by a multiplication factor M. FIG. 4 shows an augmented system that includes an intermediate plate 32 with an arrangement of conical apertures 34 for pixel isolation and focussing light. Each conical aperture 34 is positioned for the enhancement of the optical signals received by a specific photoconductor 36 in the array plate 2.

If the surface of the photoconductor is circular, as in FIG. 1, a cylindrical lens is preferred. Alternatively, if the surface of the photoconductor area is linear, as may be needed to minimize the capacitance, then a linear lens is preferred. A preferred shape for the conical aperture is a Winston cone.

The resistance relationship given by Eq. 1 includes the light multiplication factor M corresponds to the addition of a lens for multiplication of the optical power. Typically, M is a pixel-level multiplication factor that reflects the amplification of the incident light intensity P due to an array of miniature lenses as indicated in FIG. 4 to give a local optical power density incident P_{local}=M*P on the photodetector.

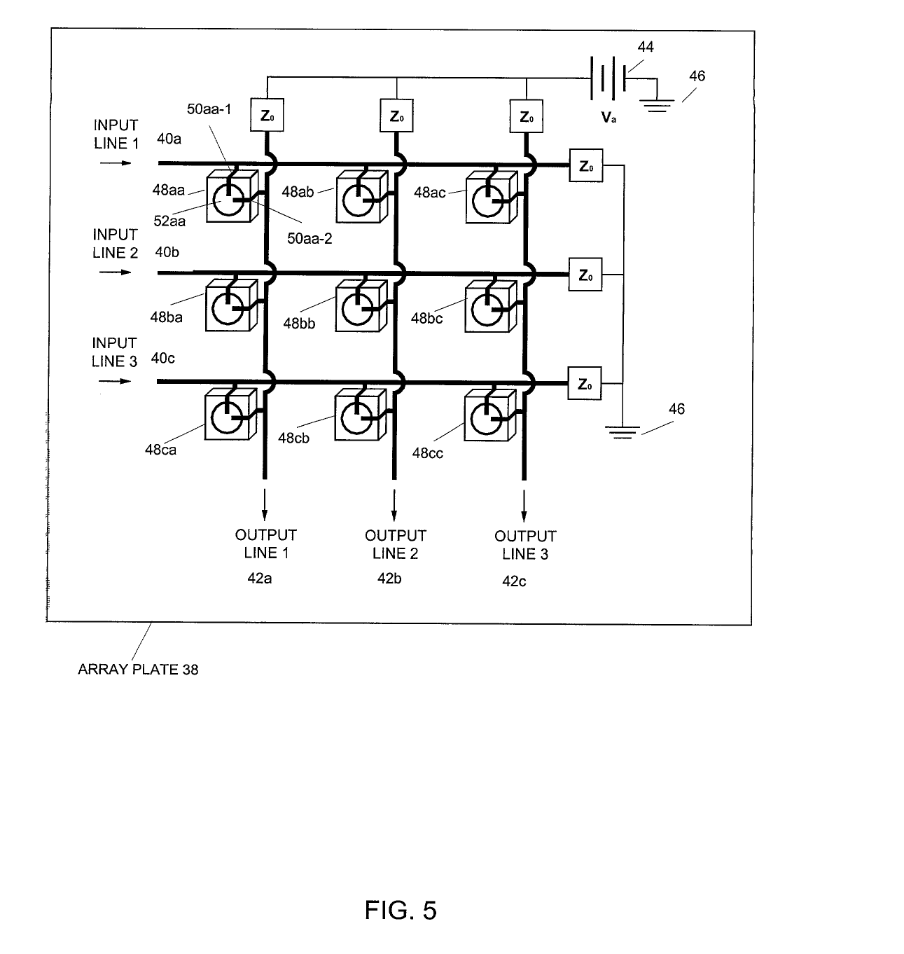

The photoconductors 12aa-12cc may be made from semiconductor materials such as Si and GaAs while other portions of the array plate 2 may be made from a non-conducting substrate such as quartz so that microwave transmission losses will be minimized. In FIG. 5 a specifically preferred embodiment of an array plate 38 includes multiple input lines 40a -40c and multiple output lines 42a-42c, where each line has a nominal impedance of Z₀=50 ohms. A DC voltage source 44 operates to maintain an applied voltage Vₐ on the output lines 42a-42c so that a voltage differential exists between the input lines 40a-40c and the output lines 42a-42c with respect to a common ground 46. Connections between input lines 40a-40c and output lines 42a-42c are made by multiple photoconductors 48aa-48cc located at nodes joining the input lines 40a-40c and the output lines 42a-42c.

The base of the array plate 38 is a quartz substrate, and the photoconductors 48aa-48cc are tiles made from Si. This combination can be made by fastening a thin layer of Si to a quartz substrate. Then the Si sheet on the quartz substrate can be etched into a multiplicity of tiles. Finally the tiles can be connected by metalization lines which provide pathways for the microwave signals. These metalization lines include the input lines 40a-40c and the output lines 42a-42c. Additionally metalization lines are used to connect the photoconductors 48aa-48cc to the input lines 40a-40c and the output lines 42a-42c; for example, the first photoconductor 48aa is connected to the first input line 40a by a first connection line 50aa-1 and to the first output line 42a by a second connection line 50aa-2. The connection lines 50aa-1, 50aa-2 overlap a circular region 52aa of the first photoconductor that represents the area illuminated by a light beam during operation of the array plate 38.

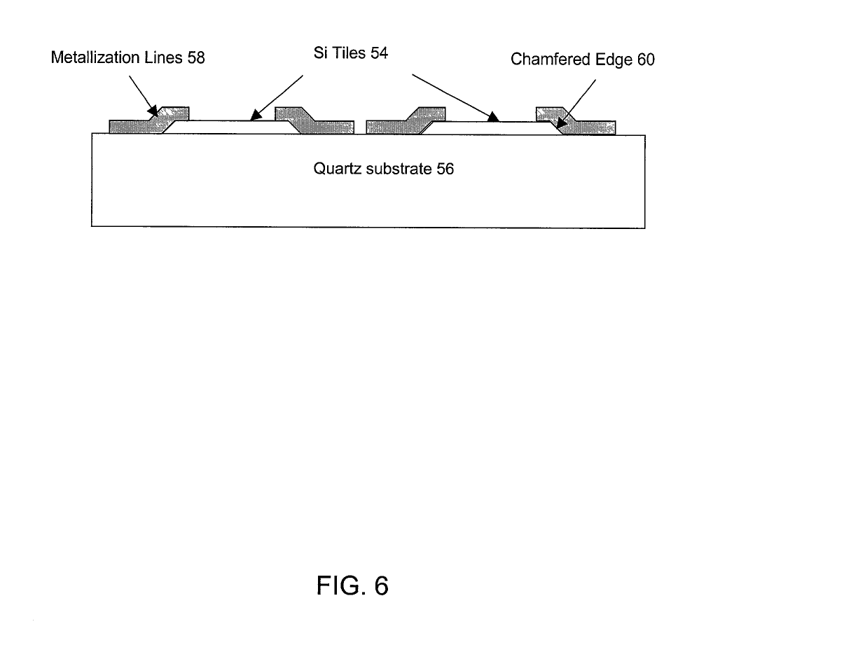

The conductivity between a photoconductor 48aa and its corresponding connection lines 50aa-1, 50aa-2 may be enhanced by certain details of the design. In FIG. 6, two Silicon tiles 54 representing photoconductors are shown mounted on a quartz substrate 56 representing the base of an array plate. Metalization lines 58 (i.e., connection lines) contact the silicon tiles 54 with a chamfered edge 60 to enhance the surface coverage of the connection.

The Silicon tiles 54 are shown with chamfered edges 60 produced by known etching processes. In the embodiment shown in FIG. 5, a microwave signal must pass through a single tile 48aa-48cc before exiting the array plate 2. Therefore, this small transport dimension allows the use of Silicon in the tile even though Silicon has a relatively high absorption coefficient for microwaves.

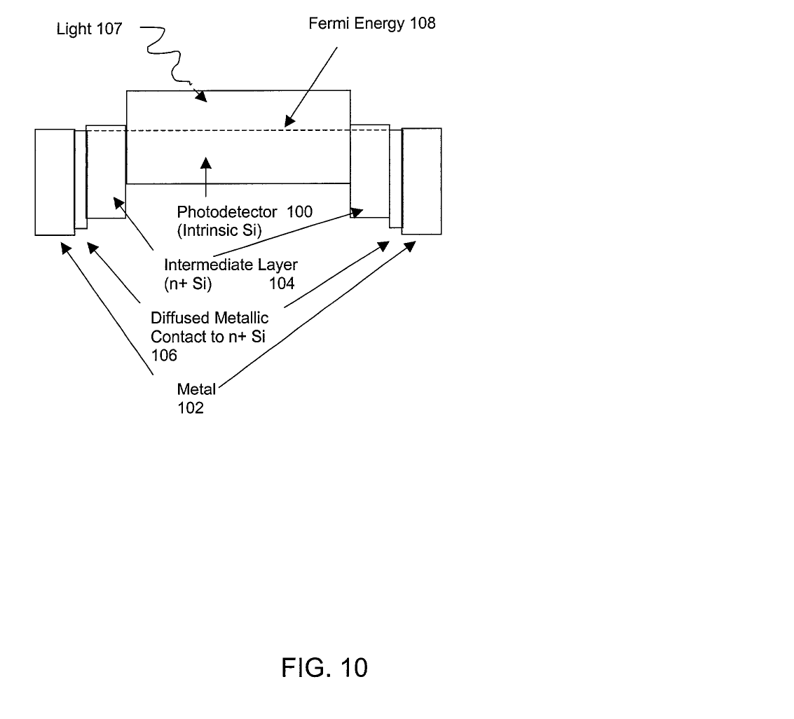

For highest gain, it is important to use the purest materials available; these are nearly insulating, and good ohmic contacts are required, but difficult to manufacture. Light can be used to create charge transfer through the junction provided a neutral contact is made (e.g., a region of no band bending). (“Concepts in Photoconductivity and Allied Problems”, Albert Rose, Interscience Publishers (1963).) As shown in FIG. 10, this charge transfer can occur if a photoconductor 100 made from intrinsic Si is contacted by a metallic contact 102 through an intermediary layer 104 of n⁺Si. It is also possible to use a diffused metal silicide contact 106 to contact the n⁺intermediate layer, a technique know to make a good ohmic contact. As illustrated in FIG. 10, an incident light 107 induces a reference energy level, known as the Fermi energy 108, which is flat in the absence of an applied voltage.

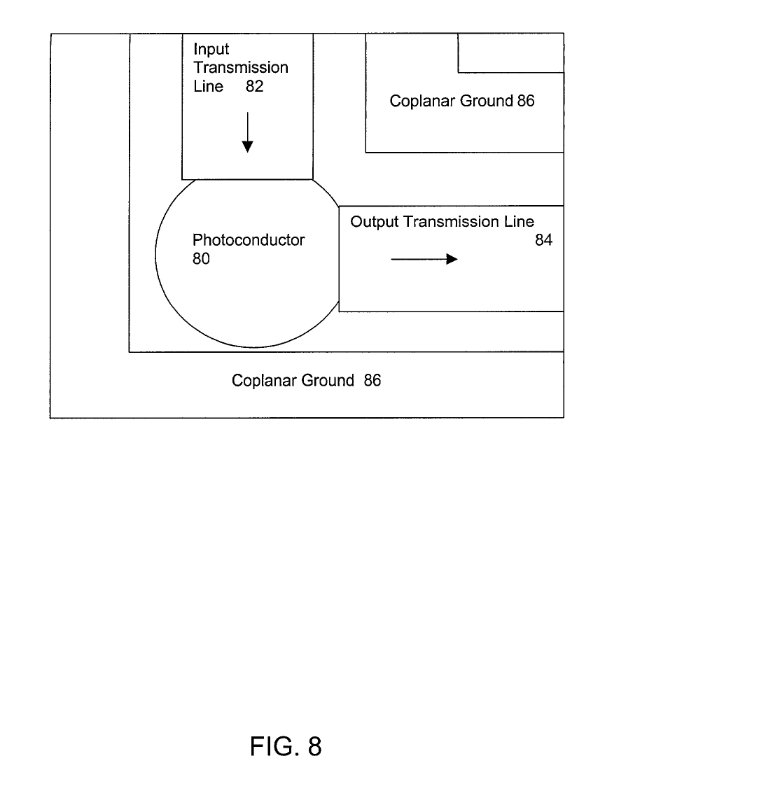

As illustrated in FIG. 8, the design of FIG. 5has the input and output microwave lines separated at a 90 degree angle. In this 90 degree design the highest photoconductivity occurs when light is focussed in the circular region of the photconductor 80 between the input 82 and output 84 transmission lines, arranged at right angles to each other and separated from a coplanar ground 86.

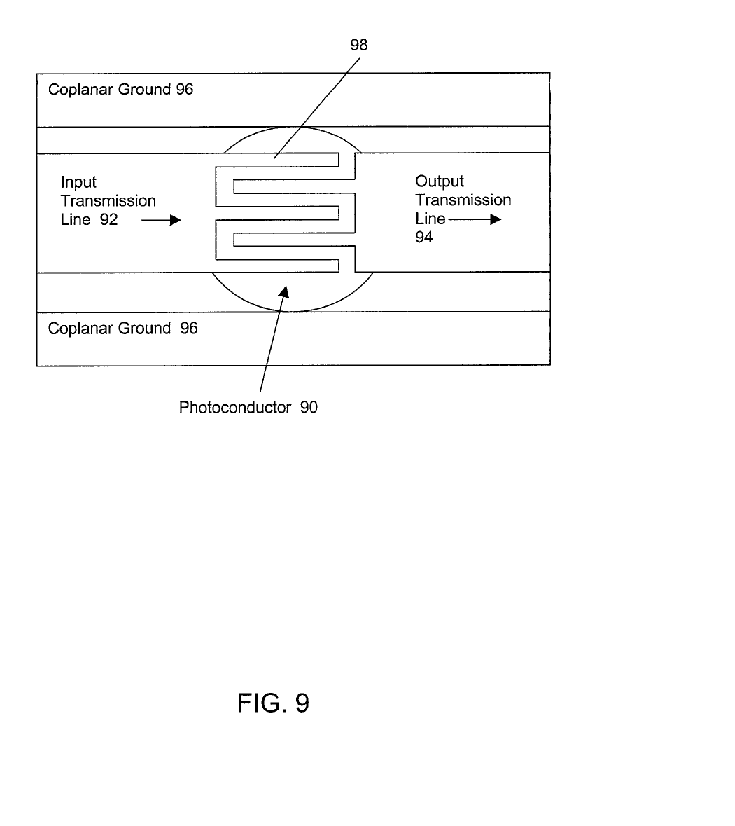

Alternative arrangements for transmission across a photoconductor are possible (e.g., different angular orientations). In the design shown in FIG. 9, the input 92 and output 94 transmission lines are arranged in parallel and separated from a coplanar ground 96 as in FIG. 7. However, the transmission embodiment of FIG. 9 includes has digital contacts 98 across the photoconductor 90. The arrangement of FIG. 9 advantageously decreases the resistance across the photoconductor 90 for the same optical power level as compared with the arrangement of FIG. 7. That is, increasing the power density P and multiplication factor M results in a lower resistance according to Eq. 1 and hence better performance. FIGS. 7-9 illustrate embodiments of the present invention that enable focussing of light onto small areas that connect transmission lines. Microwaves will propagate properly in the designs of FIGS. 7, 8, or 9, provided the light intensity is high enough so that the photoconductor series resistance is small compared to Z₀=50 ohms.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A system for switching microwave signals, comprising:
an array plate, the array plate including an array of analog switches having a plurality of input lines and a plurality of output lines, the input lines being connected to the output lines by a by a plurality of photoconductors, the array plate including a DC bias source for creating a voltage differential across the photoconductors, and the photoconductors being sufficiently doped so that exposure to light substantially affects the conductivity of the photoconductors;
a frame;
a display projector connected to the array plate by the frame, the display projector including a display surface and a light source, the display surface facing the array plate and separating the display surface from the light source, and the display surface including at least one display aperture for transmitting light, wherein
light emitted from the light source passes through a first display aperture and strikes a first photoconductor so that a circuit from a first input line to a first output line is completed.

2. A system as claimed in claim 1, further comprising: an intermediate plate having a plurality of intermediate apertures for focussing and isolating light, wherein light that is emitted from the light source and that passes through the first display aperture passes through a first intermediate aperture before striking the first photoconductor.

3. A system as claimed in claim 1, wherein
the display surface is responsive to display commands for determining two-dimensional positions of said at least one display aperture in the display surface, the display surface being substantially opaque away from said at least one display aperture; and
the display projector further comprises an input device and a computer for executing a display program, the display program including code for:
receiving display input from the input device,
determining display commands from the display input, and
transmitting the display commands to the display surface.

4. A system as claimed in claim 3, wherein the two-dimensional positions of said at least one display aperture are selected from a set that corresponds to the positions of the photoconductors relative to the light source.

5. A system as claimed in claim 1, wherein
the array plate further comprises a base that includes quartz; and
the photoconductors include silicon

6. A system as claimed in claim 5, wherein the array plate further comprises a plurality of input connectors that electrically connect the input lines to the photoconductors and a plurality of output line connectors that electrically connect the output lines to the photoconductors.

7. A system as claimed in claim 6, wherein
a first input connector from the first input line includes a chamfered edge at the first photoconductor, and
a first output connector from the first output line includes a chamfered edge at the first photoconductor.

8. A system as claimed in claim 6, wherein
a first input connector from the first input line includes at least one finger extending onto the first photoconductor, and
a first output connector from the first output line includes at least one finger extending onto the first photoconductor.

9. A system as claimed in claim 6, wherein
a first input connector from the first input line includes an intermediate layer of n-type silicon, and
a first output connector from the first output line includes an intermediate layer of n-type silicon.

10. A system as claimed in claim 9, wherein
the first input connector further includes a diffused metallic contact between the intermediate layer and the first input line, and
the first output connector further includes a diffused metallic contact between the intermediate layer and the first output line.

11. An array plate for switching microwave signals, comprising:
an array of analog switches having a plurality of input lines and a plurality of output lines,
a plurality of photoconductors that connect the input lines to the output lines; the photoconductors being sufficiently doped so that exposure to light substantially affects the conductivity of the photoconductors; and
a DC bias source for creating a voltage differential across the photoconductors, wherein
exposing a first photoconductor to light completes a circuit from a first input line to a first output line.

12. An array plate as claimed in claim 11, further comprising a base that includes quartz, wherein the photoconductors include silicon

13. An array plate as claimed in claim 12, further comprising a plurality of input connectors that electrically connect the input lines to the photoconductors and a plurality of output line connectors that electrically connect the output lines to the photoconductors.

14. An array plate as claimed in claim 13, wherein
a first input connector from the first input line includes a chamfered edge at the first photoconductor, and
a first output connector from the first output line includes a chamfered edge at the first photoconductor.

15. An array plate as claimed in claim 13, wherein
a first input connector from the first input line includes at least one finger extending onto the first photoconductor, and
a first output connector from the first output line includes at least one finger extending onto the first photoconductor.

16. An array plate as claimed in claim 13, wherein
a first input connector from the first input line includes an intermediate layer of n-type silicon, and
a first output connector from the first output line includes an intermediate layer of n-type silicon.

17. An array plate as claimed in claim 16, wherein
the first input connector further includes a diffused metallic contact between the intermediate layer and the first input line, and
the first output connector further includes a diffused metallic contact between the intermediate layer and the first output line.

18. A projection system comprising:
a light source,
a display surface, the display surface being responsive to display commands for determining two-dimensional positions of at least one display aperture in the display surface for transmitting light emitted from the light source, the display surface being substantially opaque away from said at least one display aperture;
an input device; and
a computer for executing a display program, the display program including code for:
receiving display input from the input device,
determining display commands from the display input, and
transmitting the display commands to the display surface.

19. A system as claimed in claim 18, wherein the two-dimensional positions of said at least one display aperture are selected from a set that corresponds to the positions of targets of the light source.

20. A system as claimed in claim 19, further comprising: an auxiliary plate having a plurality of auxiliary apertures for focussing and isolating light emitted from the light source, the two-dimensional positions of the auxiliary apertures corresponding to the positions of the targets of the light source.
